(19) United States
(12) Patent Application Publication
(10) Pub. No.: US 2020/0251797 A1
(43) Pub. Date: Aug. 6, 2020

(54) ANTENNA DEVICE INCLUDING PHASE SHIFTER

(71) Applicant: Samsung Electronics Co., Ltd., Suwon-si (KR)

(72) Inventors: Young-Jong KIM, Anyang-si (KR); Dongsik SHIN, Suwon-si (KR); Jonghwa KIM, Seoul (KR); Hae-Gweon PARK, Suwon-si (KR); Byungtae YOON, Suwon-si (KR); Jong Wook ZEONG, Suwon-si (KR); Soon-Ho HWANG, Seoul (KR)

(21) Appl. No.: 16/651,843

(22) PCT Filed: Sep. 11, 2018
(86) PCT No.: PCT/KR2018/010619

§ 371 Date: Mar. 27, 2020

(30) Foreign Application Priority Data
Sep. 27, 2017 (KR) 10-2017-0125219

(51) Int. Cl. H01P 1/18

(52) U.S. Cl. CPC H01P 1/18

(57) ABSTRACT

The present disclosure relates to a pre-5^{th}-Generation (5G) or 5G communication system to be provided for supporting higher data rates beyond 4^{th}-Generation (4G) communication system such as long-term evolution (LTE). A phase shifter device according to various embodiments of the present disclosure may include: a first board configured to comprise a phase changing rail; and a second board configured to comprise an input rail connected to an input port, a first output rail connected to a first output port, a second output rail connected to a second output port, and a connection rail connecting the first output rail with the second output rail. The first board may be disposed to be spaced a predetermined distance apart from the second board so as to face and overlay the second board. The phase of a signal passing through a first section of the connection rail may vary by a first value depending on the rotation of the first board. The signal may be divided into a first signal transmitted to the first output port and a second signal transmitted to the second output port.

### CROSS-REFERENCE TO RELATED APPLICATIONS

This application is a 371 of International Application No. PCT/KR2018/010619 filed on Sep. 11, 2018, which claims priority to Korean Patent Application No. 10-2017-0125219 filed on Sep. 27, 2017, the disclosures of which are herein incorporated by reference in their entirety.

### BACKGROUND

### 1. Field

The present disclosure relates generally to antenna devices and, more particularly, to antenna devices that include phase shifters.

### 2. Description of Related Art

In domestic and foreign mobile communication systems, the density of subscribers varies by region and time zone, so that the network management is performed to adjust the coverage of the base station by adjusting the vertical beam angle of the base station antenna to provide an optimal service in such a situation.

To this end, the conventional beam communication system uses a mechanical beam tilt method. Such a mechanical tilt method is a method of directly adjusting the direction of an antenna radiation beam by adjusting an angle of an antenna using a mechanical beam tilt device mounted to an antenna.

An advantage of the mechanical beam tilt method is that the production cost of the antenna can be lowered. However, for the base station to operate, there is a risk of falling and a lot of time because a technician goes directly to the base station antenna tower to unscrew the bolts holding the beam tilt mechanism, change the angle of the antenna, and then tighten the bolts again. This takes less time to repair.

In order to solve this problem, an electric beam tilt method for remotely adjusting the beam tilt of the base station antenna has been developed. The electric beam tilt antenna has a phase shifter for adjusting the phase of the beam therein.

Based on the discussion as described above, the present disclosure provides an antenna device that includes a phase shifter.

In addition, the present disclosure, in changing the phase of the signal transmitted to each output port according to the rotation of the first board, one output port included in the second board using one connection line included in the second board in addition to the phase of the signal to be delivered to the phase shifter for adjusting the phase of the signal transmitted to the other output port included in the second board.

### SUMMARY

According to various embodiments of the present disclosure, a phase shifter device may include: a first substrate configured to include a phase changing rail; and a second substrate configured to include an input rail connected to an input port, a first output rail connected to a first output port, a second output rail connected to a second output port, and a connection rail connecting the first output rail with the second output rail. The first substrate may be disposed to be spaced a predetermined distance apart from the second substrate so as to face and overlay the second substrate. The phase of a signal passing through a first section of the connection rail may vary by a first value depending on the rotation of the first substrate. The signal may be divided into a first signal transmitted to the first output port and a second signal transmitted to the second output port.

According to various embodiments of the present disclosure, an antenna device may include: a housing; a first radiating element and a second radiating element configured to be disposed inside the housing; and a phase shifter configured to be disposed inside the housing. The phase shifter may include a first substrate configured to include a phase changing rail and a second substrate configured to include an input rail connected to an input port, a first output rail connected to a first output port, a second output rail connected to a second output port, and a connection rail connecting the first output rail with the second output rail. The first substrate may be disposed to be spaced a predetermined distance apart from the second substrate so as to face and overlay the second substrate. The phase of a signal passing through a first section of the connection rail may vary by a first value depending on the rotation of the first substrate. The signal may be divided into a first signal transmitted to the first output port and a second signal transmitted to the second output port.

The device according to various embodiments of the present disclosure has a structure capable of adjusting the phases of respective signals transmitted to different output ports using a single connection line, thereby reducing the size of a phase shifter.

Effects which can be acquired by the present disclosure are not limited to the above described effects, and other effects that have not been mentioned may be clearly understood by those skilled in the art from the following description.

### BRIEF DESCRIPTION OF THE DRAWINGS

FIG. 1A illustrates a perspective view and a front view of a beam-tilt antenna according to various embodiments of the present disclosure;

FIG. 1B illustrates another perspective view of a beam-tilt antenna according to various embodiments of the present disclosure;

FIG. 1C illustrates a perspective view of a housing of a beam-tilt antenna according to various embodiments of the present disclosure;

FIG. 2A illustrates a perspective view of a phase shifter according to various embodiments of the present disclosure;

FIG. 2B illustrates a front view of a phase shifter according to various embodiments of the present disclosure;

FIG. 2C illustrates an exploded perspective view of a phase changer according to various embodiments of the present disclosure;

FIGS. 3A to 3D illustrate front views of a phase changer before and after rotation of a first board according to a first embodiment of the present disclosure;

FIGS. 4A to 4D illustrate phase graphs for respective output ports according to a first embodiment of the present disclosure;

FIGS. 5A to 5C illustrate front views of a phase changer before and after rotation of a first board according to a second embodiment of the present disclosure;

FIGS. 6A to 6D illustrate phase graphs for respective output ports according to a second embodiment of the present disclosure;

FIGS. 7A to 7C illustrate front views of a phase changer before and after rotation of a first board according to a third embodiment of the present disclosure;

FIG. 8A illustrates a graph for a power split ratio according to a first embodiment of the present disclosure;

FIG. 8B illustrates an S-parameter graph for the reflection coefficient according to a first embodiment of the present disclosure;

FIG. 9A illustrates a graph for a power split ratio according to a second embodiment of the present disclosure;

FIG. 9B illustrates an S-parameter graph for the reflection coefficient according to a second embodiment of the present disclosure;

FIG. 10A illustrates an example of a beam pattern change of a beam-tilt antenna depending on a phase change according to a first embodiment of the present disclosure;

FIG. 10B illustrates an example of a beam pattern change of a beam-tilt antenna depending on a phase change according to a second embodiment of the present disclosure;

FIG. 11A illustrates a vertical beam pattern characteristic diagram of a beam-tilt antenna according to various embodiments of the present disclosure; and

FIG. 11B illustrates a horizontal beam pattern characteristic diagram of a beam-tilt antenna according to various embodiments of the present disclosure.

### DETAILED DESCRIPTION

The terms used in the present disclosure are only used to describe specific embodiments, and are not intended to limit other embodiments. Singular expressions may include plural expressions as well unless the context clearly indicates otherwise. All terms used herein including technical and scientific terms may have the same meaning as those commonly understood by a person skilled in the art to which the present disclosure pertains. Terms such as those defined in a generally used dictionary among the terms used in the present disclosure may be interpreted to have the meanings equal or similar to the contextual meanings in the relevant field of art, and are not to be interpreted to have ideal or excessively formal meanings unless clearly defined in the present disclosure. In some cases, even a term defined in the present disclosure should not be interpreted to exclude embodiments of the present disclosure.

In various embodiments of the present disclosure to be described below, a hardware approach will be described as an example. However, since the various embodiments of the present disclosure include a technology using both hardware and software, the various embodiments of the present disclosure do not exclude a software-based approach.

Hereinafter, the present disclosure relates to an antenna device. Specifically, the present disclosure describes a beam tilt antenna device that includes a phase shifter.

Terms used in the following description (e.g., input lines, output lines, transmission lines, phase change lines), terms referring to the components of the apparatus (modified according to the invention as appropriate), etc. are provided for convenience of description. It is. Thus, the present disclosure is not limited to the terms described below, and other terms having equivalent technical meanings may be use.

Hereinafter, various embodiments will be described in detail with reference to the accompanying drawings. However, in the drawings, the size of the components may be exaggerated or reduced for convenience of description. For example, the size and thickness of each component shown in the drawings are arbitrarily shown for convenience of description, and thus the present invention is not necessarily limited to the illustrated.

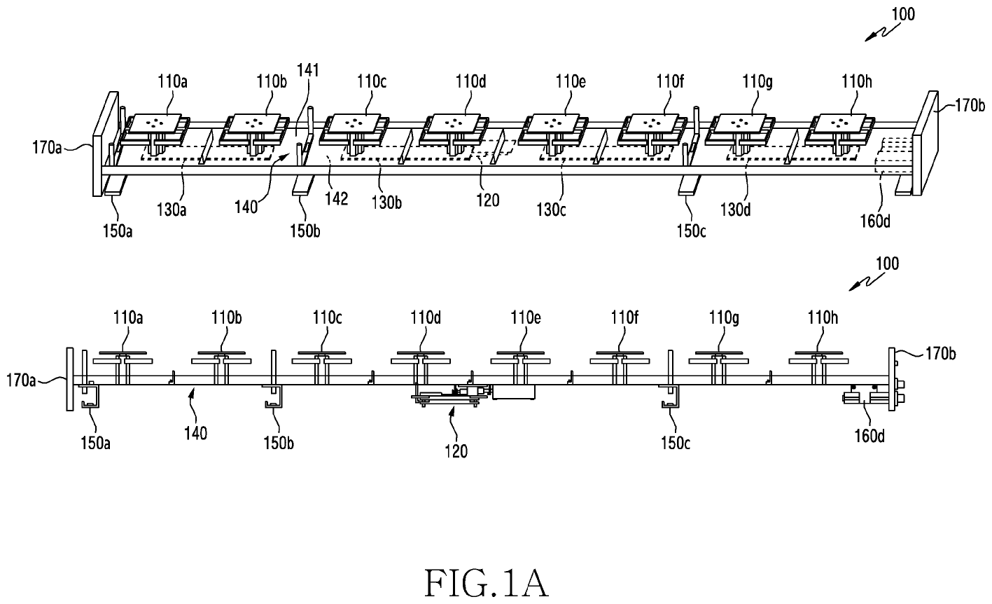

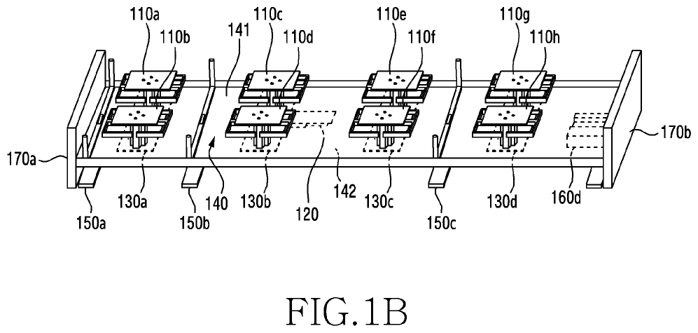

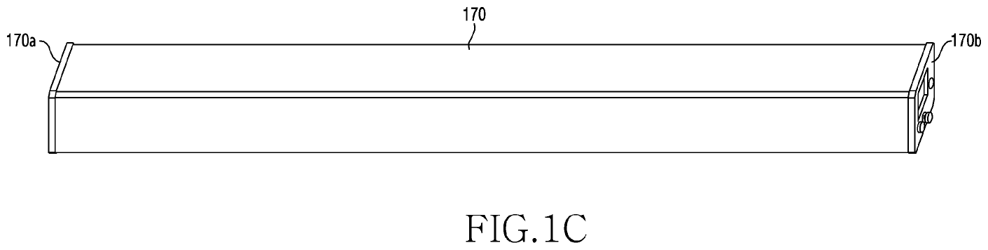

FIG. 1A illustrates a perspective view and a front view of a beam tilt antenna according to various embodiments of the present disclosure. FIG. 1B illustrates another perspective view of a beam tilt antenna according to various embodiments of the present disclosure. FIG. 1.C is a perspective view of a housing of a beam tilt antenna according to various embodiments of the present disclosure.

According to FIG. 1A to 1C, the beam tilt antenna 100 includes a reflector 140. The reflector plate 140 may be fixed by being spaced apart from one surface of the inside of the housing 170 by fixing members 150a to 150c. The reflector 140 may improve the directivity and the gain of the signal by reflecting the signals emitted from the radiating elements 110a to 110h.

Radiating elements 110a to 110h are disposed on the first surface 141 of the reflector 140. In this case, two adjacent radiating elements among the radiating elements 110a to 110h (for example, radiating element 110a and radiating element 110b, radiating element 110c and radiating element 110d, radiating element 110e and radiating element 110f, radiating element 110g and radiating element 110h)) can be configured in pairs to emit the same signal from the same output port. In some embodiments, as shown in FIG. 1a, in the reflective plate 140, the radiating elements 110a to 110h may be disposed in a 1×8 form. In other embodiments, as shown in the reflector 140, the radiating elements 110a to 110h may be disposed in a 2×4 shape.

The phase shifter 120, the conductive members 130a to 130d, and the input/output terminal 160 are disposed on the second surface 142 of the reflective plate 140. The phase shifter 120 adjusts the phase of the signal input to the input port and delivers it to the output port. The conductive members 130a to 130d may transmit a phase-adjusted signal output from each output port of the phase shifter 120 to the radiating elements 110a to 110h. Accordingly, the radiating elements 110a to 110h emit a signal whose phase is adjusted. That is, the phase shifter 120 controls the radiation pattern (e.g., direction) of the signal output from the radiating elements 110a to 110h by adjusting the phase of the input signal.

The input/output terminal 160 may receive a signal generated by a processor and a radio frequency (RF) circuit of a transmitter (e.g., a base station) (not shown) including the antenna 100. Thereafter, the input/output terminal 160 may transmit an input signal to the phase shifter 120.

The radiating element 110a, the radiating element 110b, the phase shifter 120, the conductive member 130, and the input/output end 160 disposed on the first surface 141 and the second surface 142 of the reflecting plate 140 are embedded in the housing 170, the cover 170a, and the cover 170b.

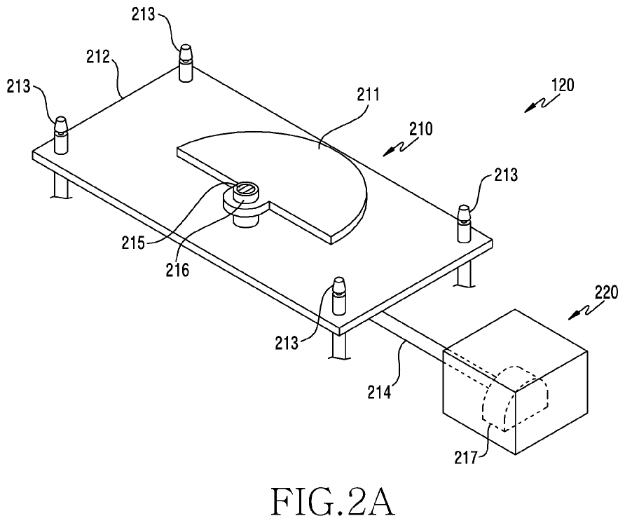

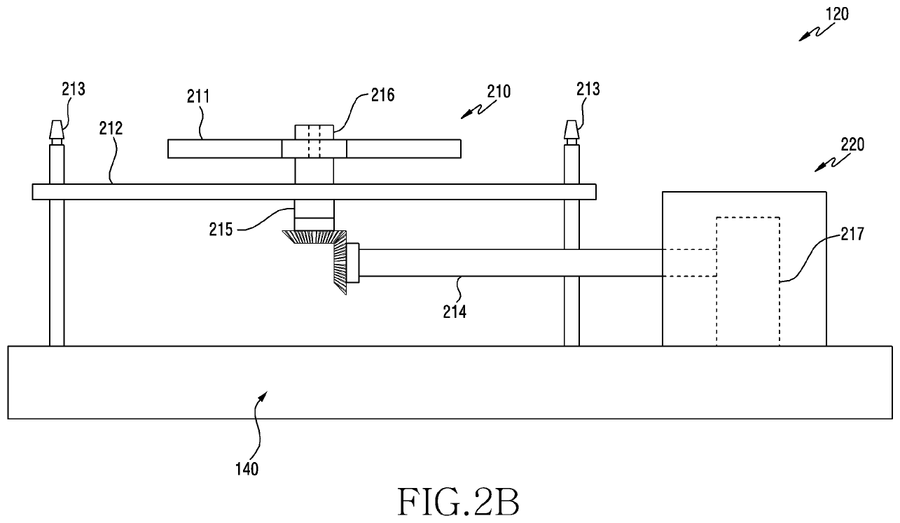

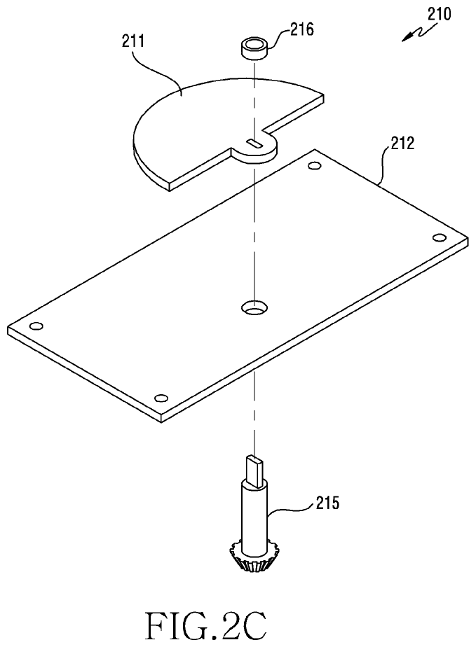

FIG. 2A illustrates a perspective view of a phase shifter according to various embodiments of the present disclosure. FIG. 2B illustrates a front view of a phase shifter according to various embodiments of the present disclosure.

Referring to FIGS. 2A and 2B, the phase shifter 120 includes a phase changer 210 and a driving part 220.

The phase changer 210 includes a first board 211 and a second board 212 disposed to face each other. For example, the first board 211 and the second board 212 may be referred to as “printed circuit boards (PCBs)”. In some embodiments, the first board 211 may be spaced a predetermined distance apart from the second board 212 so as to face and overlay the same.

A first bevel gear 215 is engaged with a second bevel gear 214, and the second bevel gear 214 is rotated by a motor 217 included in the driving part 220, thereby rotating the first bevel gear 215. In this case, a bolt provided at the end of the first bevel gear 215 passes through the first board 211 and the second board 212 so as to engage with a nut 216. Thus, the first board 211 is fixed to the first bevel gear 215, and the first board 211 is rotated by the rotation of the first bevel gear 215. In addition, the second board 212 is fixed to the reflector 140 by a board fixing piece 213. However, the gear for rotating the first board 211 is not limited to a bevel gear, and various types of gears may be used.

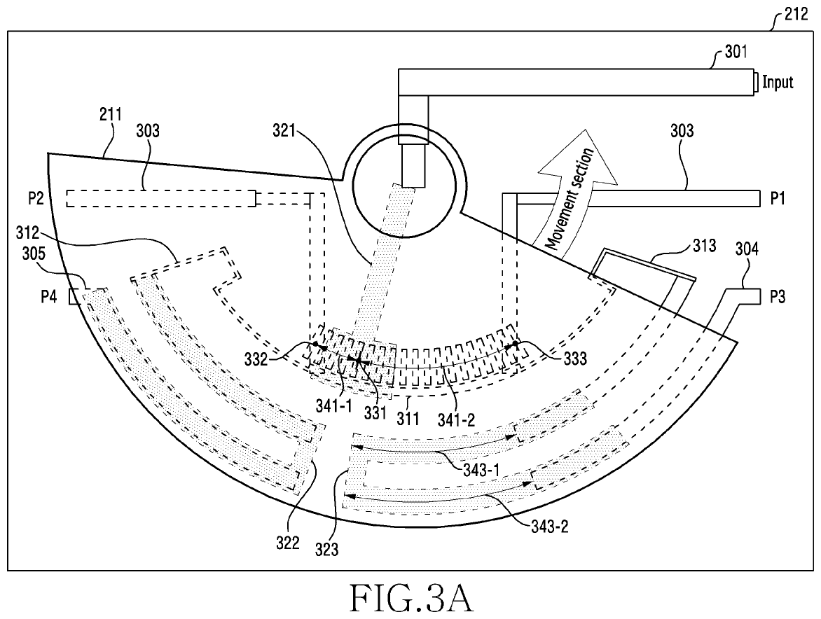

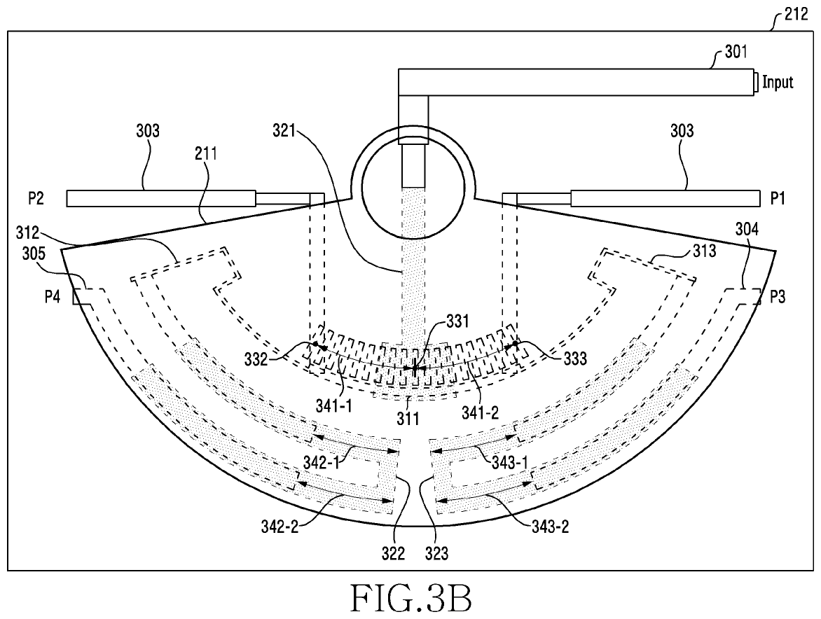

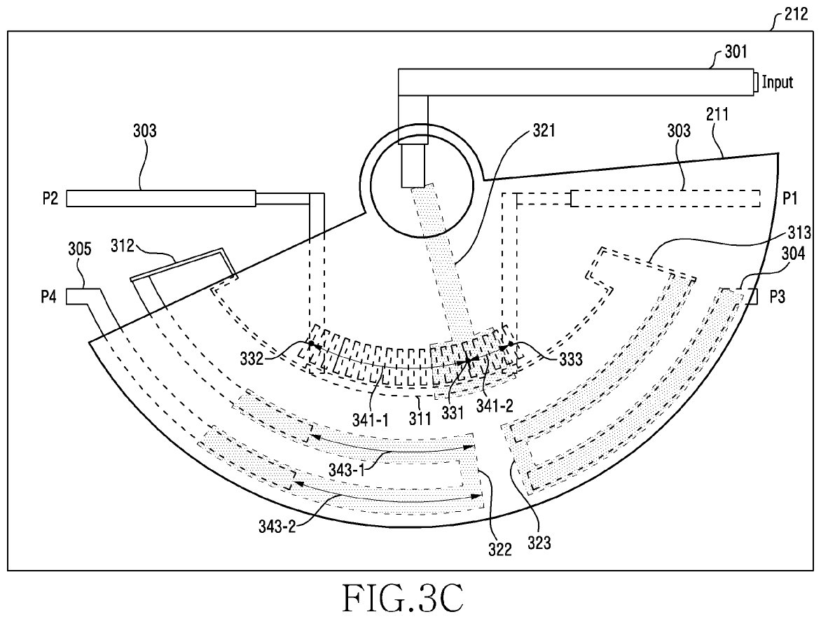

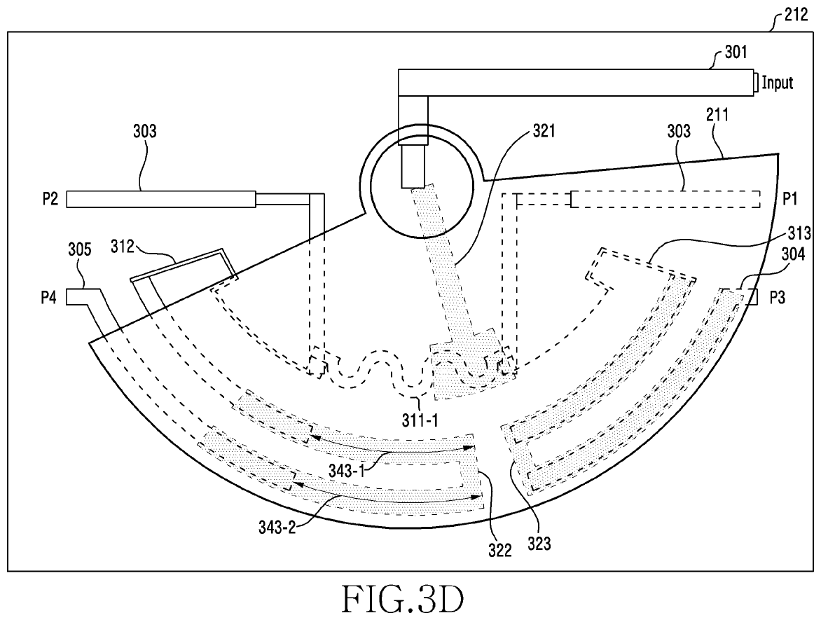

FIGS. 3A to 3D illustrate front views of a phase changer before and after rotation of a first board according to a first embodiment of the present disclosure.

Referring to FIGS. 3A to 3C, the first board 211 includes a phase changing rail 321, a phase changing rail 322, and a phase changing rail 323. The second board 212 includes an input rail 301 connected to an input port, an output rail 302 connected to an output port P1, an output rail 303 connected to an output port P2, an output rail 304 connected to an output port P3, an output rail 305 connected to an output port P4, and connection rails 311 to 313. The connection rail 311 may connect the output rail 302 and the output rail 303. The connection rail 312 may be connected to the point where the connection rail 311 and the output rail 303 are connected. The connection rail 313 may be connected to the point where the connection rail 311 and the output rail 302 are connected. The connection rail 311 may include a comb pattern (or comb-shaped) rail. For example, the connection rail 311 may have a comb-line shape. In this case, the phase speed of a signal passing through the connection rail 311 may be slowed by the comb-line shape of the connection rail 311. Thus, the amount of phase change per unit length of the connection rail 311 including the comb-line may be greater than the amount of phase change per unit length of a rail (e.g., the phase changing rail 322 or the phase changing rail 323) that does not include the comb-line. As another example, referring to FIG. 3D, the connection rail 311 may include a wave pattern (or wave-shaped) rail. In addition, the connection rail 311 may be formed of various types of rails.

The respective thicknesses of the various rails included in FIGS. 3A to 3C may be designed to be different from each other in order to match impedance between neighboring rails.

A signal transmitted from the input port and passing through the input rail 301 is divided at a first division point 331 into a signal heading for the output ports P1 and P3 and a signal heading for the output ports P2 and P4. The first division point 331 may refer to the center of the portion where the comb pattern rail of the connection rail 311 and the connection rail 311 are coupled to each other.

Thereafter, the signal that has passed through a first section 341-1 of the connection rail 311 and heads for the output ports P2 and P4 is divided again at a second division point 332 into a signal transmitted to the output port P2 and a signal transmitted to the output port P4. The second division point 332 may refer to the point where the connection rail 311, the connection rail 312, and the output rail 303 are connected to each other. In addition, the signal that has passed a second section 341-2 of the connection rail 311 and heads for the output ports P1 and P3 is divided again at a third division point 333 into a signal transmitted to the output port P1 and a signal transmitted to the output port P3. The third division point 333 may refer to the point where the connection rail 311, the connection rail 313, and the output rail 302 are connected to each other. In addition, the first section 341-1 may refer to the portion that ranges from the first division point 331 to the second division point 332 in the connection rail 311. The second section 341-2 may refer to the portion that ranges from the first division point 331 to the third division point 333 in the connection rail 311.

The signal transmitted to the output port P2 passes through the output rail 303, and the signal transmitted to the output port P4 passes through a third section 342-1 and a fourth section 342-2 of the connection rail 312. The third section 342-1 may refer to a candidate portion that may be further coupled to the connection rail 312 in the phase changing rail 322 when the first board 211 rotates. The fourth section 342-2 may refer to a candidate portion that may be further coupled to the connection rail 313 in the phase changing rail 323 when the first board 211 rotates.

In some embodiments, when the first board 211 rotates, the third section 342-1 and the fourth section 342-2 may be different from each other in the amount of change in the length thereof because the arc length of the first board 211 varies depending on the radius thereof during the rotation of the first board 211. Thus, as the first board 211 rotates, the amounts of changes in the phases of the signals passing through the third section 342-1 and the fourth section 342-2 may be different. In some embodiments, considering the distance from the rotational axis of the first board 211, the amount of change in the length of the first section 341-1 may be less than those of the third section 342-1 and the fourth section 342-2 when the first board 211 rotates. Thus, in this case, although the connection rail 311 has a comb-line shape, the amount of change in the phase of the signal passing through the first section 341-1 may be less than those of the signals passing through the third section 342-1 and the fourth section 342-2.

The signal transmitted to the output port P1 passes through the output rail 302, and the signal transmitted to the output port P3 passes through a fifth section 343-1 and a sixth section 343-2 of the connection rail 313. The fifth section 343-1 may refer to the portion where the coupling with the connection rail 313 is released in the phase changing rail 323 as the first board 211 rotates. The sixth section 343-2 may refer to the portion where the coupling with the output rail 304 is released in the phase changing rail 323 as the first board 211 rotates.

As the first board 211 rotates, the length of the first section 341-1 increases by the rotation angle of the first board 211. Accordingly, the phase of the signal passing through the first section 341-1 and heading for the output ports P2 and P4 increases by a second phase (β°).

When the first board 211 rotates, the length of the output rail 303 does not vary, so that the phase of the signal transmitted to the output port P2 after the rotation of the first board 211 varies by +β°, compared to that before the rotation of the first board 211.

In addition, as the first board 211 rotates, the lengths of the third section 342-1 and the fourth section 342-2 increase by the rotation angle of the first board 211, respectively. Thus, the phase of the signal passing through the third section 342-1 and the fourth section 342-2 and transmitted to the output port P4 increases by a first phase (α°). The increased first phase ((α°) may be the sum of the phase increments by the third section 342-1 and the fourth section 342-2, respectively. As a result, the phase of the signal transmitted to the output port P4 after the rotation of the first board 211 varies by +α°+β°, compared to that before the rotation of the first board 211.

On the other hand, as the first board 211 rotates, the length of the second section 341-2 decreases by the rotation angle of the first board 211. Thus, the phase of the signal passing through the second section 341-2 and heading for the output ports P1 and P3 decreases by a second phase (β°).

As the first board 211 rotates, the length of the output rail 302 does not vary, so that the phase of the signal transmitted to the output port P1 after the rotation of the first board 211 varies by −β°, compared to that before the rotation of the first board 211.

In addition, as the first board 211 rotates, the lengths of the fifth section 343-1 and the sixth section 343-2 decrease by the rotation angle of the first board 211, respectively. Thus, the phase of the signal passing through the fifth section 343-1 and the sixth section 343-2 and transmitted to the output port P3 decreases by a first phase (α°). The decreased first phase (α°) may be the sum of the phase decrements by the fifth section 343-1 and the sixth section 343-2, respectively. As a result, the phase of the signal transmitted to the output port P3 after the rotation of the first board 211 varies by −α°−β°, compared to that before the rotation of the first board 211.

In this case, it can be seen that the phase change amount (−β°) of the signal transmitted to the output port P1 and the phase change amount (+β°) of the signal transmitted to the output port P2, according to the rotation of the first board 211, have a symmetrical relationship with each other. In addition, it can be seen that the phase change amount (−α°−β°) of the signal transmitted to the output port P3 and the phase change amount (+α°+β°) of the signal transmitted to the output port P4, according to the rotation of the first board 211, have a symmetrical relationship with each other.

When changing the phases of the signals transmitted to the respective output ports according to the rotation of the first board 211, the first section 341-1 may be used to adjust, as well as the phase of the signal transmitted to the output port P2, the phase of the signal transmitted to the output port P4 by the same second phase (β°). That is, since a connection rail for adjusting the phase of the signal transmitted to the output port P2 by the second phase (β°) and a connection rail for adjusting the phase of the signal transmitted to the output port P4 by the second phase (β°) are not separately required, the size of the phase shifter 120 can be reduced.

In this case, the length of the second section 341-2 decreases in response to an increase in the length of the first section 341-1 according to the rotation of the first board 211. That is, the phase of the signal heading for the output ports P1 and P3 reversely varies in response to a change in the phase of the signal heading for the output ports P2 and P4 by the connection rail 311.

As described above, when the first board 211 and the second board 212 have a rail structure as shown in FIGS. 3A and 3B, the phase change amount of a signal transmitted to each output port according to the rotation of the first board 211 may be determined as shown in Table 1 below.

TABLE 1

| | Phases | |
|---|---|---|
| Output ports | Reference | Amount of change |
| P1 | 0° | −β° |
| P2 | 0° | +β° |
| P3 | 0° | −α° − β° |
| P4 | 0° | +α° + β° |

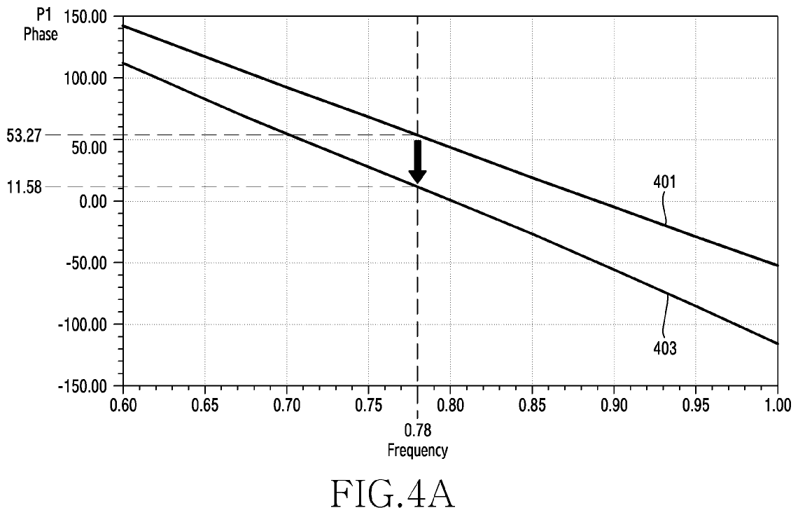

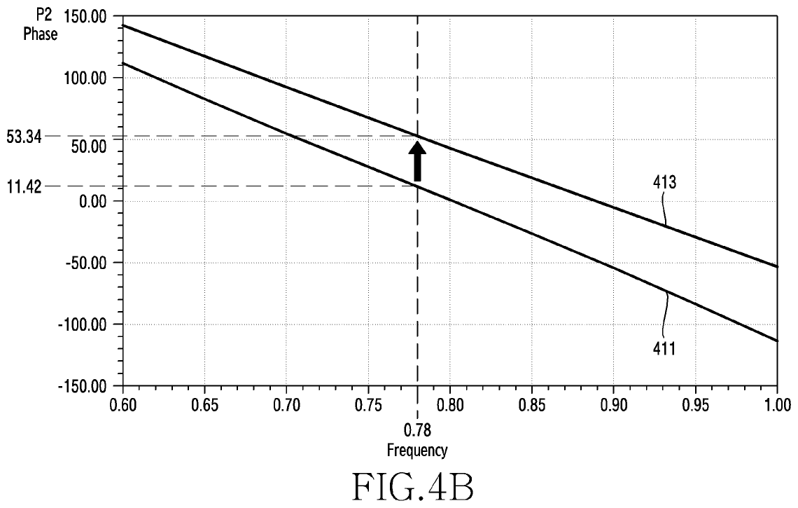

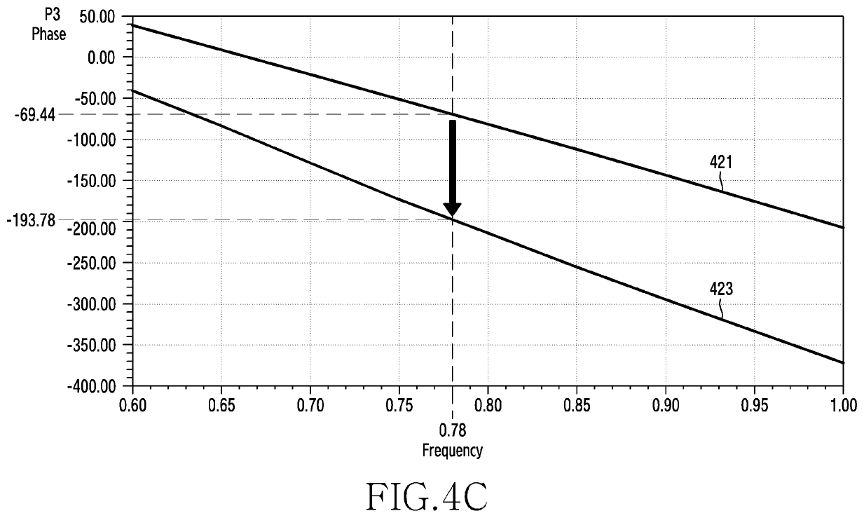

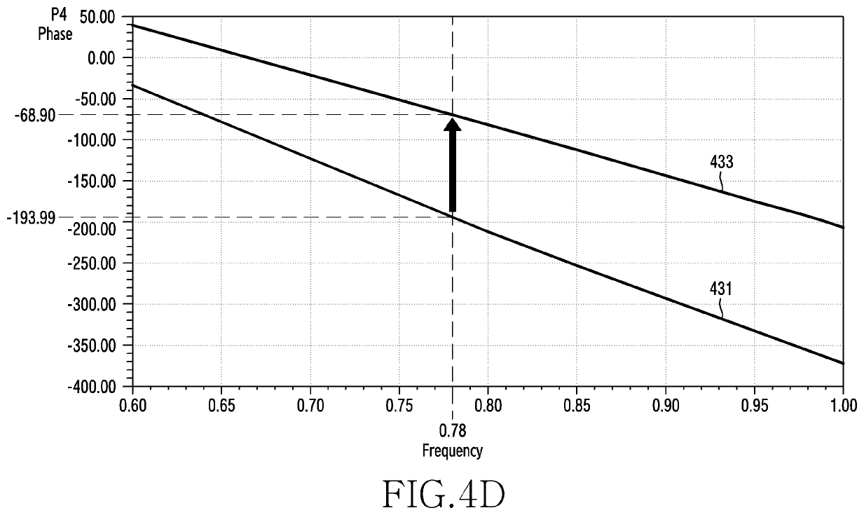

FIGS. 4A to 4D illustrate phase graphs for respective output ports according to a first embodiment of the present disclosure. FIGS. 4A to 4D illustrate phase graphs for respective output ports in the case where the first board 211 and the second board 212 have a rail structure as shown in FIGS. 3A to 3C. Here, the x-axis of the phase graph represents a frequency of a signal transmitted to each output port, and the y-axis represents a phase of a signal transmitted to each output port.

Referring to FIG. 4A, a straight line 401 represents a phase of the signal transmitted to the output port P1 corresponding to each frequency before the first board 211 rotates. A straight line 403 represents a phase of the signal transmitted to the output port P1 corresponding to each frequency after the first board 211 rotates. For example, in the case where the frequency of a signal transmitted to the output port P1 is 0.78 GHz, if the phase of the signal transmitted to the output port P1 before the rotation of the first board 211 is +53.27°, the phase of the signal transmitted to the output port P1 after the rotation of the first board 211 may be +11.58°. That is, the phase change amount of the signal transmitted to the output port P1, which is generated due to the rotation of the first board 211, may be about −42°. In some embodiments, when the first board 211 and the second board 212 have a rail structure as shown in FIGS. 3A to 3C, the phase change amount (−β°) of the signal transmitted to the output port P1 may be −42°.

Referring to FIG. 4B, a straight line 411 represents a phase of a signal transmitted to the output port P2 corresponding to each frequency before the first board 211 rotates. A straight line 413 represents a phase of a signal transmitted to the output port P2 corresponding to each frequency after the first board 211 rotates. For example, in the case where the frequency of the signal transmitted to the output port P2 is 0.78 GHz, if the phase of the signal transmitted to the output port P2 before the rotation of the first board 211 is +11.42° the phase of the signal transmitted to the output port P2 after the rotation of the first board 211 may be +53.34°. That is, the phase change amount of the signal transmitted to the output port P2, which is generated due to the rotation of the first board 211, may be about +42°. In some embodiments, when the first board 211 and the second board 212 have a rail structure as shown in FIGS. 3A to 3C, the phase change amount (+β°) of the signal transmitted to the output port P2 may be +42°.

Referring to FIG. 4C, a straight line 421 represents a phase of a signal transmitted to the output port P3 corresponding to each frequency before the first board 211 rotates. A straight line 423 represents a phase of a signal transmitted to the output port P3 corresponding to each frequency after the first board 211 rotates. For example, in the case where the frequency of the signal transmitted to the output port P3 is 0.78 GHz, if the phase of the signal transmitted to the output port P3 before the rotation of the first board 211 is −69.44°, the phase of the signal transmitted to the output port P3 after the rotation of the first board 211 may be −193.78°. That is, the phase change amount of the signal transmitted to the output port P3, which is generated due to the rotation of the first board 211, may be about −124°. In some embodiments, when the first board 211 and the second board 212 have a rail structure as shown in FIGS. 3A to 3C, the phase change amount (−α°−β°) of the signal transmitted to the output port P3 may be −124°.

Referring to FIG. 4D, a straight line 431 represents a phase of a signal transmitted to the output port P4 corresponding to each frequency before the first board 211 rotates. A straight line 433 represents a phase of a signal transmitted to the output port P4 corresponding to each frequency after the first board 211 rotates. For example, in the case where the frequency of the signal transmitted to the output port P4 is 0.78 GHz, if the phase of the signal transmitted to output port P4 before the rotation of the first board 211 is −193.99°, the phase of the signal transmitted to the output port P4 after the rotation of the first board 211 may be −68.90°. That is, the phase change amount of the signal transmitted to the output port P4, which is generated due to the rotation of the first board 211, may be about +124°. In some embodiments, when the first board 211 and the second board 212 have a rail structure as shown in FIGS. 3A to 3C, the phase change amount (+α°+β°) of the signal transmitted to the output port P4 may be +124°.

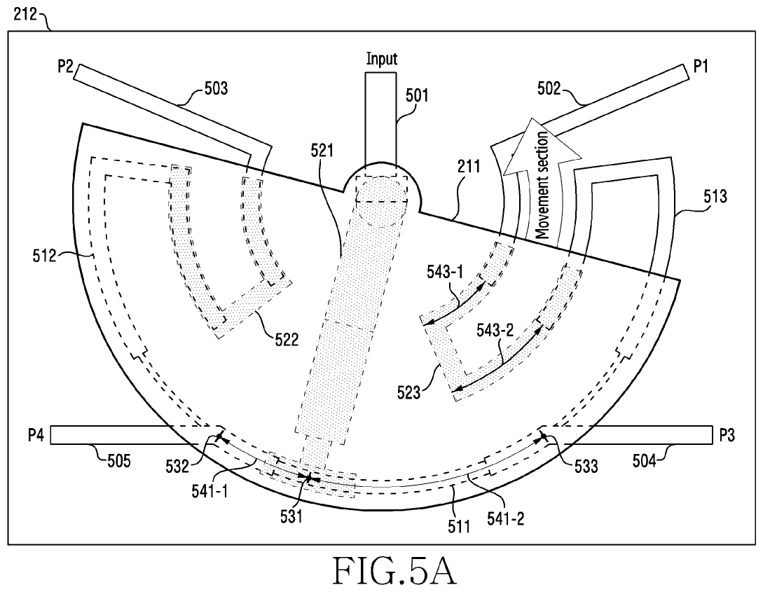

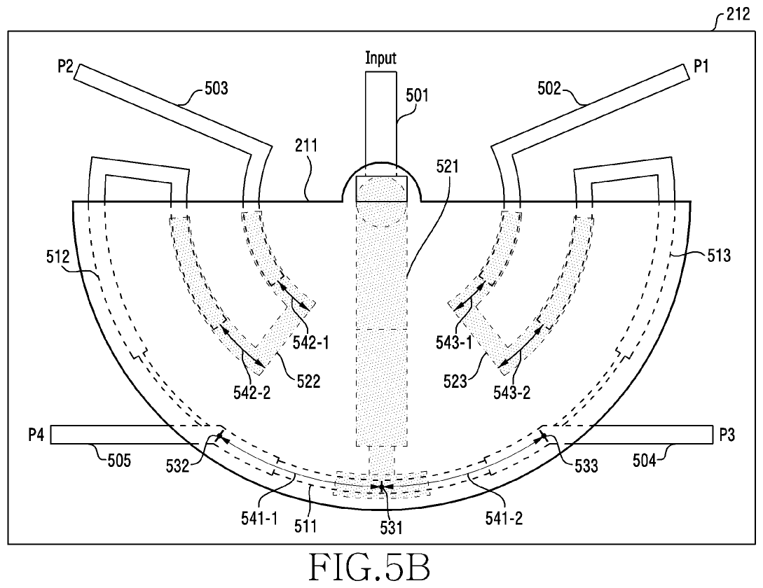

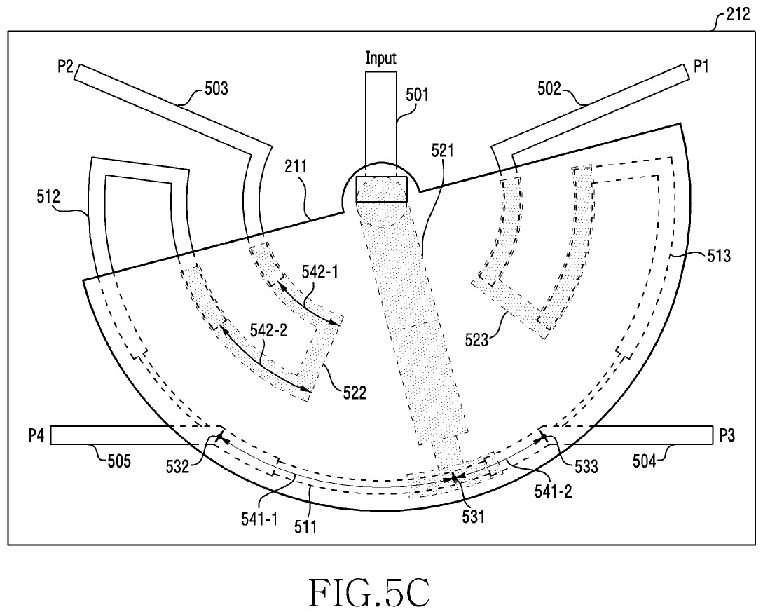

FIGS. 5A to 5C illustrate front views of a phase changer before and after rotation of a first board according to a second embodiment of the present disclosure.

Referring to FIGS. 5A to 5C, the first board 211 includes a phase changing rail 521, a phase changing rail 522, and a phase changing rail 523. The second board 212 includes an input rail 501 connected to an input port, an output rail 502 connected to an output port P1, an output rail 503 connected to an output port P2, an output rail 504 connected to an output port P3, an output rail 505 connected to an output port P4, and connection rails 511 to 513. The connection rail 511 may connect the output rail 504 and the output rail 505. The connection rail 512 may be connected to the point where the connection rail 511 and the output rail 505 are connected. The connection rail 513 may be connected to the point where the connection rail 511 and the output rail 504 are connected. The respective thicknesses of the various rails included in FIGS. 5A to 5C may be designed to be different from each other in order to match impedance between neighboring rails. In this case, since the connection rail 511 does not include a comb-pattern rail, the size of the phase shifter 120 may be reduced. In addition, since the connection rail 511 does not include a comb-pattern rail, the phase shifter 120 can more precisely control the phase change amount of the signal transmitted to each output port.

A signal transmitted from the input port and passing through the input rail 501 is divided at a first division point 531 into a signal heading for the output ports P1 and P3 and a signal heading for the output ports P2 and P4. The first division point 531 may refer to the center of the portion where the phase changing rail 521 and the connection rail 511 are coupled to each other.

Thereafter, the signal that has passed through a first section 541-1 of the connection rail 511 and heads for the output ports P2 and P4 is divided again at a second division point 532 into a signal transmitted to the output port P2 and a signal transmitted to the output port P4. The second division point 532 may refer to a point where the connection rail 511, the connection rail 512, and the output rail 505 are connected to each other. In addition, the signal that has passed a second section 541-2 of the connection rail 511 and heads for the output ports P1 and P3 is divided again at a third division point 533 into a signal transmitted to the output port P1 and a signal transmitted to the output port P3. The third division point 533 may refer to a point where the connection rail 511, the connection rail 513, and the output rail 504 are connected to each other. In addition, the first section 541-1 may refer to the portion that ranges from the first division point 531 to the second division point 532 in the connection rail 511. The second section 541-2 may refer to the portion that ranges from the first division point 531 to the third division point 533 in the connection rail 511.

The signal transmitted to the output port P2 passes through a third section 542-1 and a fourth section 542-2 of the connection rail 512, and the signal transmitted to the output port P4 passes through the output rail 505. The third section 342-1 may refer to a portion where the coupling with the output rail 503 is released in the phase changing rail 522 as the first board 211 rotates. The fourth section 542-2 may refer to a portion where the coupling with the connection rail 513 is released in the phase changing rail 523 as the first board 211 rotates.

In some embodiments, when the first board 211 rotates, the third section 542-1 and the fourth section 542-2 may be different from each other in the amount of change in the length thereof because the arc length of the first board 211 varies depending on the radius thereof during the rotation of the first board 211. Thus, as the first board 211 rotates, the phase change amounts of the signals passing through the third section 542-1 and the fourth section 542-2 may be different from each other. In some embodiments, since the length of the phase changing rail 521 is greater than that of the phase changing rail 321 shown in FIG. 3B, the amount of change in the length of the first section 541-1 in FIG. 5B may be greater than the amount of change in the length of the first section 341-1 in FIG. 3B according to the rotation of the first board 211. Thus, although the connection rail 511 does not have a comb-line shape, the phase change amount of the signal passing through the first section 541-1 in FIG. 5B according to the rotation of the first board 211 may be greater than that of the signal passing through the first section 341-1 in FIG. 3B.

The signal transmitted to the output port P1 passes through a fifth section 543-1 and a sixth section 543-2 in the connection rail 513, and the signal transmitted to the output port P3 passes through the output rail 504. The fifth section 543-1 may refer to a candidate portion that may be further coupled to the output rail 502 in the phase changing rail 523 when the first board 211 rotates. The sixth section 543-2 may refer to a candidate portion that may be further coupled to the connection rail 513 in the phase changing rail 523 when the first board 211 rotates.

In this case, as the first board 211 rotates, the length of the first section 541-1 increases by the rotation angle of the first board 211. Accordingly, the phase of the signal passing through the first section 541-1 and heading for the output ports P2 and P4 increases by a first phase (α°).

As the first board 211 rotates, the lengths of the third section 542-1 and the fourth section 542-2 increase by the rotation angle of the first board 211, respectively. Thus, the phase of the signal passing through the third section 542-1 and the fourth section 542-2 and transmitted to the output port P2 increases by a second phase (β°). The increased second phase (β°) may be the sum of the phase increments by the third section 542-1 and the fourth section 542-2, respectively. As a result, the phase of the signal transmitted to the output port P2 after the rotation of the first board 211 varies by +α°+β°, compared to that before the rotation of the first board 211.

In addition, as the first board 211 rotates, the length of the output rail 505 does not vary, so that the phase of the signal transmitted to the output port P4 after the rotation of the first board 211 varies by +α, compared to that before the rotation of the first board 211.

On the other hand, as the first board 211 rotates, the length of the second section 541-2 decreases by the rotation angle of the first board 211. Thus, the phase of the signal passing through the second section 541-2 and heading for the output ports P1 and P3 decreases by a first phase (α°).

As the first board 211 rotates, the lengths of the fifth section 543-1 and the sixth section 543-2 decrease by the rotation angle of the first board 211, respectively. Thus, the phase of the signal passing through the fifth section 543-1 and the sixth section 543-2 and transmitted to the output port P1 decreases by a second phase (β°). The decreased second phase (β) may be the sum of the phase decrements by the fifth section 543-1 and the sixth section 543-2, respectively. As a result, the phase of the signal transmitted to the output port P1 after the rotation of the first board 211 varies by −α°−β°, compared to that before the rotation of the first board 211.

In addition, as the first board 211 rotates, the length of the output rail 504 does not vary, so that the phase of the signal transmitted to the output port P3 after the rotation of the first board 211 varies by −α°, compared to that before the rotation of the first board 211.

In this case, it can be seen that the phase change amount (−α°−β°) of the signal transmitted to the output port P1 and the phase change amount (+α°+β°) of the signal transmitted to the output port P2, according to the rotation of the first board 211, have a symmetrical relationship with each other. In addition, it can be seen that the phase change amount (−α°) of the signal transmitted to the output port P3 and the phase change amount (+α°) of the signal transmitted to the output port P4, according to the rotation of the first board 211, have a symmetrical relationship with each other.

When changing the phases of the signals transmitted to the respective output ports according to the rotation of the first board 211, the first section 541-1 may be used to adjust, as well as the phase of the signal transmitted to the output port P2, the phase of the signal transmitted to the output port P4 by the same first phase (α°). That is, since a connection rail for adjusting the phase of the signal transmitted to the output port P2 by the first phase (α°) and a connection rail for adjusting the phase of the signal transmitted to the output port P4 by the first phase (α°) are not separately required, the size of the phase shifter 120 can be reduced.

In this case, the length of the second section 541-2 decreases in response to an increase in the length of the first section 541-1 according to the rotation of the first board 211. That is, the phase of the signal heading for the output ports P1 and P3 reversely varies in response to a change in the phase of the signal heading for the output ports P2 and P4 by the connection rail 511.

As described above, when the first board 211 and the second board 212 have a rail structure as shown in FIGS. 5A and 5C, the phase change amount of a signal transmitted to each output port according to the rotation of the first board 211 may be determined as shown in Table 2 below.

TABLE 2

| | Phases | |
|---|---|---|
| Output ports | Reference | Amount of change |
| P1 | 0° | −α° − β° |
| P2 | 0° | +α° + β° |
| P3 | 0° | −α° |
| P4 | 0° | +α° |

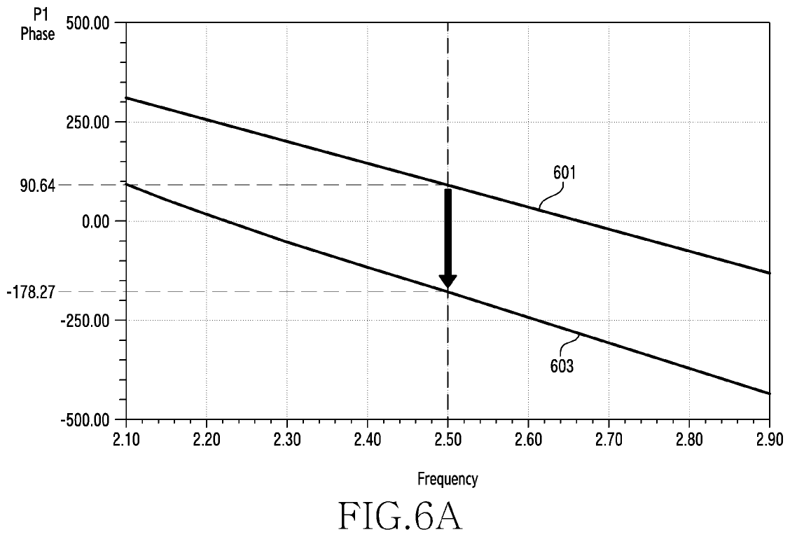

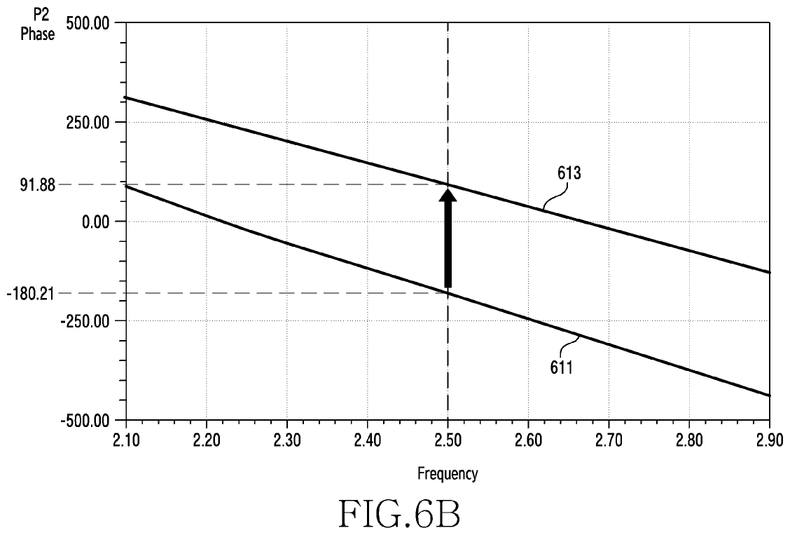

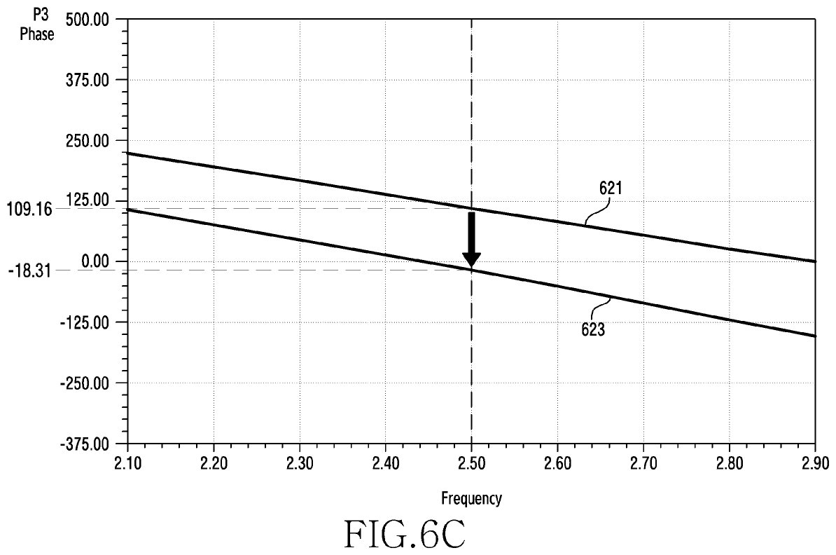

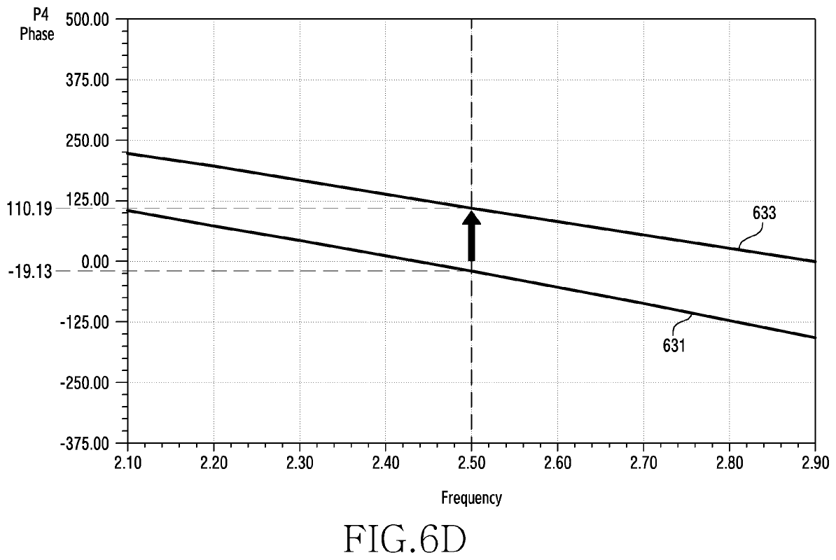

FIGS. 6A to 6D illustrate phase graphs for respective output ports according to a second embodiment of the present disclosure. FIGS. 6A to 6D illustrate phase graphs for respective output ports in the case where the first board 211 and the second board 212 have a rail structure as shown in FIGS. 5A to 5C. Here, the x-axis of the phase graph represents a frequency of a signal transmitted to each output port, and the y-axis represents a phase of a signal transmitted to each output port.

Referring to FIG. 6A, a straight line 601 represents a phase of the signal transmitted to the output port P1 corresponding to each frequency before the first board 211 rotates. A straight line 603 represents a phase of the signal transmitted to the output port P1 corresponding to each frequency after the first board 211 rotates. For example, in the case where the frequency of a signal transmitted to the output port P1 is 2.50 GHz, if the phase of the signal transmitted to the output port P1 before the rotation of the first board 211 is +90.64°, the phase of the signal transmitted to the output port P1 after the rotation of the first board 211 may be −178.27°. That is, the phase change amount of the signal transmitted to the output port P1, which is generated due to the rotation of the first board 211, may be about −269°. In some embodiments, when the first board 211 and the second board 212 have a rail structure as shown in FIGS. 5A to 5C, the phase change amount (−α°−β°) of the signal transmitted to the output port P1 may be −269°.

Referring to FIG. 6B, a straight line 611 represents a phase of a signal transmitted to the output port P2 corresponding to each frequency before the first board 211 rotates. A straight line 613 represents a phase of a signal transmitted to the output port P2 corresponding to each frequency after the first board 211 rotates. For example, in the case where the frequency of the signal transmitted to the output port P2 is 2.50 GHz, if the phase of the signal transmitted to the output port P2 before the rotation of the first board 211 is −180.21°, the phase of the signal transmitted to the output port P2 after the rotation of the first board 211 may be +91.88°. That is, the phase change amount of the signal transmitted to the output port P2, which is generated due to the rotation of the first board 211, may be about +272°. In some embodiments, when the first board 211 and the second board 212 have a rail structure as shown in FIGS. 5A to 5C, the phase change amount (+α°+β°) of the signal transmitted to the output port P2 may be +272°.

Referring to FIG. 6C, a straight line 621 represents a phase of a signal transmitted to the output port P3 corresponding to each frequency before the first board 211 rotates. A straight line 623 represents a phase of a signal transmitted to the output port P3 corresponding to each frequency after the first board 211 rotates. For example, in the case where the frequency of the signal transmitted to the output port P3 is 2.50 GHz, if the phase of the signal transmitted to the output port P3 before the rotation of the first board 211 is +109.16°, the phase of the signal transmitted to the output port P3 after the rotation of the first board 211 may be −18.31°. That is, the phase change amount of the signal transmitted to the output port P3, which is generated due to the rotation of the first board 211, may be about −127°. In some embodiments, when the first board 211 and the second board 212 have a rail structure as shown in FIGS. 5A to 5C, the phase change amount (−α°) of the signal transmitted to the output port P3 may be −127°.

Referring to FIG. 6D, a straight line 631 represents a phase of a signal transmitted to the output port P4 corresponding to each frequency before the first board 211 rotates. A straight line 633 represents a phase of a signal transmitted to the output port P4 corresponding to each frequency after the first board 211 rotates. For example, in the case where the frequency of the signal transmitted to the output port P4 is 2.50 GHz, if the phase of the signal transmitted to output port P4 before the rotation of the first board 211 is −19.13°, the phase of the signal transmitted to the output port P4 after the rotation of the first board 211 may be −110.19°. That is, the phase change amount of the signal transmitted to the output port P4, which is generated due to the rotation of the first board 211, may be about +129°. In some embodiments, when the first board 211 and the second board 212 have a rail structure as shown in FIGS. 5A to 5C, the phase change amount (+α°) of the signal transmitted to the output port P4 may be +129°.

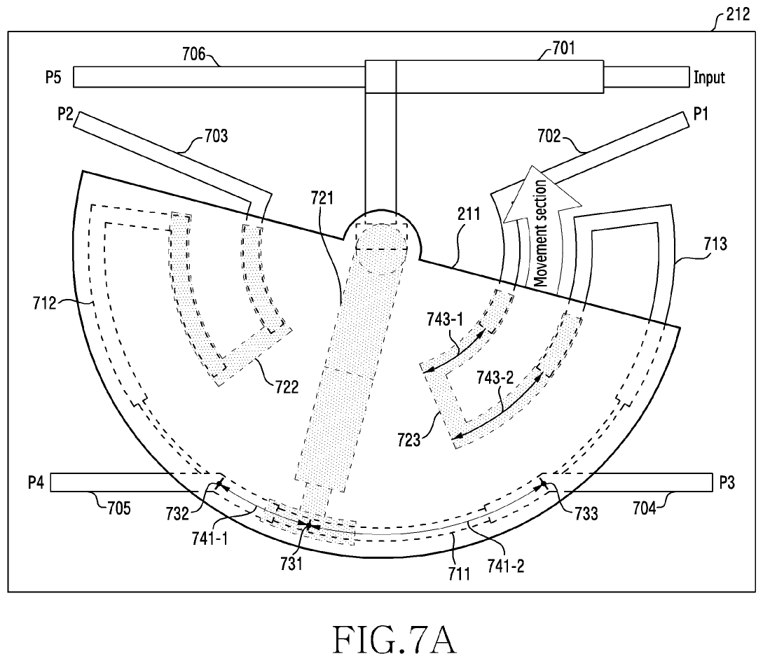

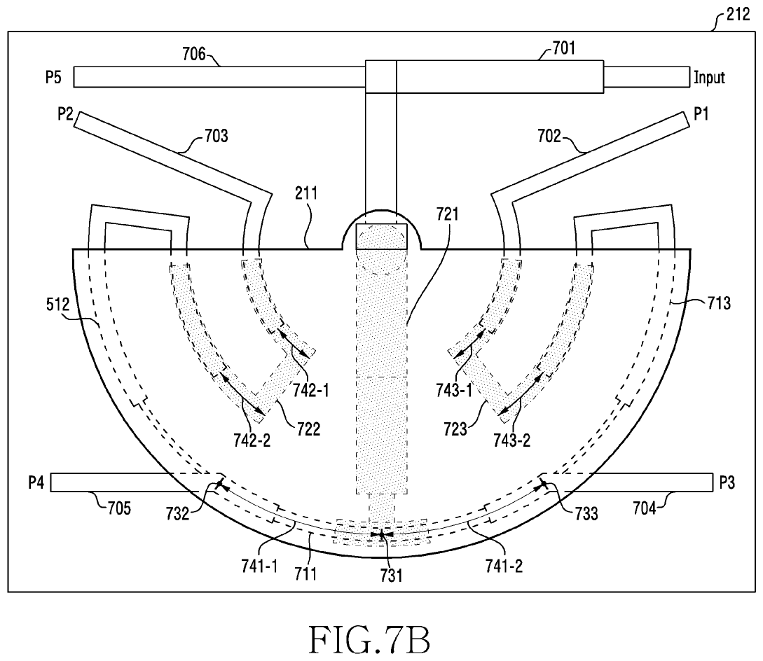

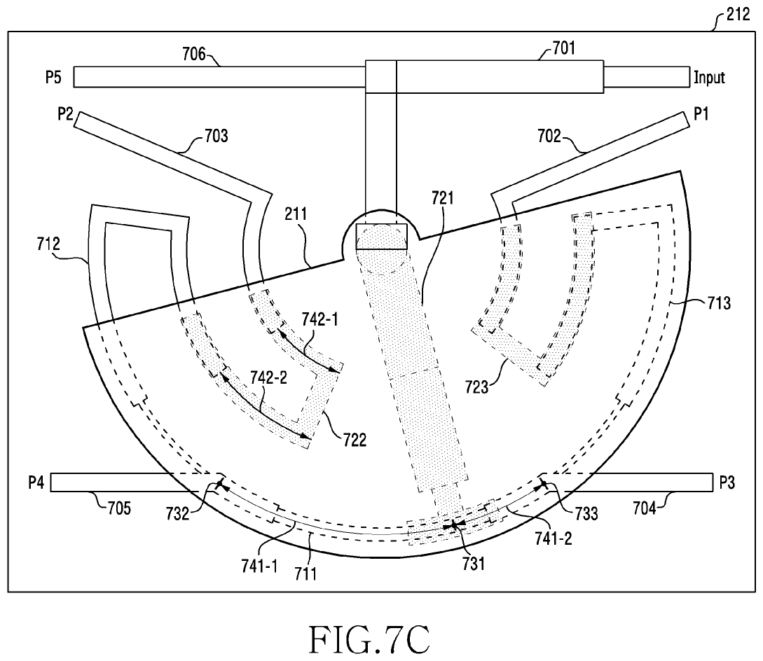

FIGS. 7A to 7C illustrate front views of a phase changer before and after rotation of a first board according to a third embodiment of the present disclosure.

Referring to FIGS. 7A to 7C, the first board 211 includes a phase changing rail 721, a phase changing rail 722, and a phase changing rail 723. The second board 212 includes an input rail 701 connected to an input port, an output rail 702 connected to an output port P1, an output rail 703 connected to an output port P2, an output rail 704 connected to an output port P3, an output rail 705 connected to an output port P4, an output rail 706 connected to an output port P5, and connection rails 711 to 713. The connection rail 711 may connect the output rail 704 and the output rail 705. The connection rail 712 may be connected to the point where the connection rail 711 and the output rail 705 are connected. The connection rail 713 may be connected to the point where the connection rail 711 and the output rail 704 are connected. The respective thicknesses of the various rails included in FIGS. 7A to 7C may be designed to be different from each other in order to match impedance between neighboring rails.

A signal transmitted from the input port and passing through the input rail 701 may be transmitted to the output port P5. In addition, an input signal transmitted from the input port and passing through the input rail 701 is divided at a first division point 731 into a signal heading for the output ports P1 and P3 and a signal heading for the output ports P2 and P4. The first division point 731 may refer to the center of the portion where the phase changing rail 721 and the connection rail 711 are coupled to each other.

Thereafter, the signal that has passed through a first section 741-1 of the connection rail 711 and heads for the output ports P2 and P4 is divided again at a second division point 732 into a signal transmitted to the output port P2 and a signal transmitted to the output port P4. The second division point 732 may refer to a point where the connection rail 711, the connection rail 712, and the output rail 705 are connected to each other. In addition, the signal that has passed a second section 741-2 of the connection rail 711 and heads for the output ports P1 and P3 is divided again at a third division point 733 into a signal transmitted to the output port P1 and a signal transmitted to the output port P3. The third division point 733 may refer to a point where the connection rail 711, the connection rail 713, and the output rail 704 are connected to each other. The first section 741-1 may refer to the portion that ranges from the first division point 731 to the second division point 732 in the connection rail 711. The second section 741-2 may refer to the portion that ranges from the first division point 731 to the third division point 733 in the connection rail 711.

The signal transmitted to the output port P2 passes through a third section 742-1 and a fourth section 742-2 of the connection rail 712, and the signal transmitted to the output port P4 passes through the output rail 705. The third section 742-1 may refer to a portion where the coupling with the output rail 703 is released in the phase changing rail 722 as the first board 211 rotates. The fourth section 742-2 may refer to a portion where the coupling with the connection rail 713 is released in the phase changing rail 723 as the first board 211 rotates.

In some embodiments, when the first board 211 rotates, the third section 742-1 and the fourth section 742-2 may be different from each other in the amount of change in the length thereof because the arc length of the first board 211 varies depending on the radius thereof during the rotation of the first board 211. Thus, as the first board 211 rotates, the phase change amounts of the signals passing through the third section 742-1 and the fourth section 742-2 may be different from each other. In some embodiments, since the length of the phase changing rail 721 is greater than that of the phase changing rail 321 shown in FIG. 3B, the amount of change in the length of the first section 741-1 in FIG. 7B may be greater than the amount of change in the length of the first section 341-1 in FIG. 3B according to the rotation of the first board 211. Thus, although the connection rail 711 does not have a comb-line shape, the phase change amount of the signal passing through the first section 741-1 in FIG. 7B according to the rotation of the first board 211 may be greater than that of the signal passing through the first section 341-1 in FIG. 3B.

The signal transmitted to the output port P1 passes through a fifth section 743-1 and a sixth section 743-2 in the connection rail 713, and the signal transmitted to the output port P3 passes through the output rail 704. The fifth section 743-1 may refer to a candidate portion that may be further coupled to the output rail 702 in the phase changing rail 723 when the first board 211 rotates. The sixth section 743-2 may refer to a candidate portion that may be further coupled to the connection rail 713 in the phase changing rail 723 when the first board 211 rotates.

In this case, the lengths of the input rail 701 and the output rail 706 do not vary when the first board 211 rotates. As a result, the phase of the signal transmitted to the output port P5 after the rotation of the first board 211 does not vary, compared to that before the rotation of the first board 211.

In addition, as the first board 211 rotates, the length of the first section 741-1 increases by the rotation angle of the first board 211. Accordingly, the phase of the signal passing through the first section 741-1 and heading for the output ports P2 and P4 increases by a first phase (α°).

As the first board 211 rotates, the lengths of the third section 742-1 and the fourth section 742-2 increase by the rotation angle of the first board 211, respectively. Thus, the phase of the signal passing through the third section 742-1 and the fourth section 742-2 and transmitted to the output port P2 increases by a second phase (β°). The increased second phase (β°) may be the sum of the phase increments by the third section 742-1 and the fourth section 742-2, respectively. As a result, the phase of the signal transmitted to the output port P2 after the rotation of the first board 211 varies by +α°+β°, compared to that before the rotation of the first board 211.

In addition, as the first board 211 rotates, the length of the output rail 705 does not vary, so that the phase of the signal transmitted to the output port P4 after the rotation of the first board 211 varies by +α°, compared to that before the rotation of the first board 211.

On the other hand, as the first board 211 rotates, the length of the second section 741-2 decreases by the rotation angle of the first board 211. Thus, the phase of the signal passing through the second section 741-2 and heading for the output ports P1 and P3 decreases by a first phase (α°).

As the first board 211 rotates, the lengths of the fifth section 743-1 and the sixth section 743-2 decrease by the rotation angle of the first board 211, respectively. Thus, the phase of the signal passing through the fifth section 743-1 and the sixth section 743-2 and transmitted to the output port P1 decreases by a second phase (β°). The decreased second phase (β°) may be the sum of the phase decrements by the fifth section 743-1 and the sixth section 743-2, respectively. As a result, the phase of the signal transmitted to the output port P1 after the rotation of the first board 211 varies by −α°−β°, compared to that before the rotation of the first board 211.

In addition, as the first board 211 rotates, the length of the output rail 704 does not vary, so that the phase of the signal transmitted to the output port P3 after the rotation of the first board 211 varies by −α°, compared to that before the rotation of the first board 211.

In this case, it can be seen that the phase change amount (−α°−β°) of the signal transmitted to the output port P1 and the phase change amount (+α°+β°) of the signal transmitted to the output port P2, according to the rotation of the first board 211, have a symmetrical relationship with each other. In addition, it can be seen that the phase change amount (−α°) of the signal transmitted to the output port P3 and the phase change amount (+α°) of the signal transmitted to the output port P4, according to the rotation of the first board 211, have a symmetrical relationship with each other.

When changing the phases of the signals transmitted to the respective output ports according to the rotation of the first board 211, the first section 741-1 may be used to adjust, as well as the phase of the signal transmitted to the output port P2, the phase of the signal transmitted to the output port P4 by the same first phase (α°). That is, since a connection rail for adjusting the phase of the signal transmitted to the output port P2 by the first phase (α°) and a connection rail for adjusting the phase of the signal transmitted to the output port P4 by the first phase (α°) are not separately required, the size of the phase shifter 120 can be reduced.

In this case, the length of the second section 741-2 decreases in response to an increase in the length of the first section 741-1 according to the rotation of the first board 211. That is, the phase of the signal heading for the output ports P1 and P3 reversely varies in response to a change in the phase of the signal heading for the output ports P2 and P4 by the connection rail 711.

As described above, when the first board 211 and the second board 212 have a rail structure as shown in FIGS. 7A and 7C, the phase change amount of a signal transmitted to each output port according to the rotation of the first board 211 may be determined as shown in Table 3 below.

TABLE 3

| | Phases | |
|---|---|---|
| Output ports | Reference | Amount of change |
| P1 | 0° | −α° − β° |
| P2 | 0° | +α° + β° |
| P3 | 0° | −α° |
| P4 | 0° | +α° |
| P5 | 0° | 0° |

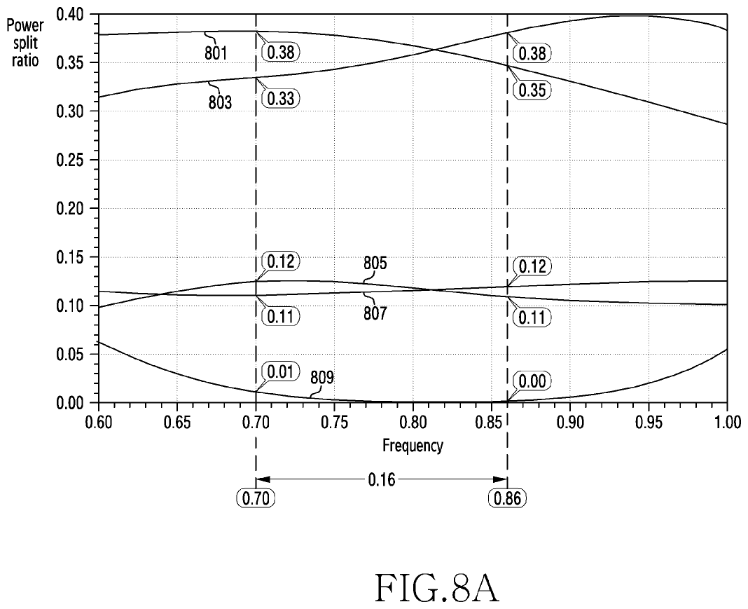

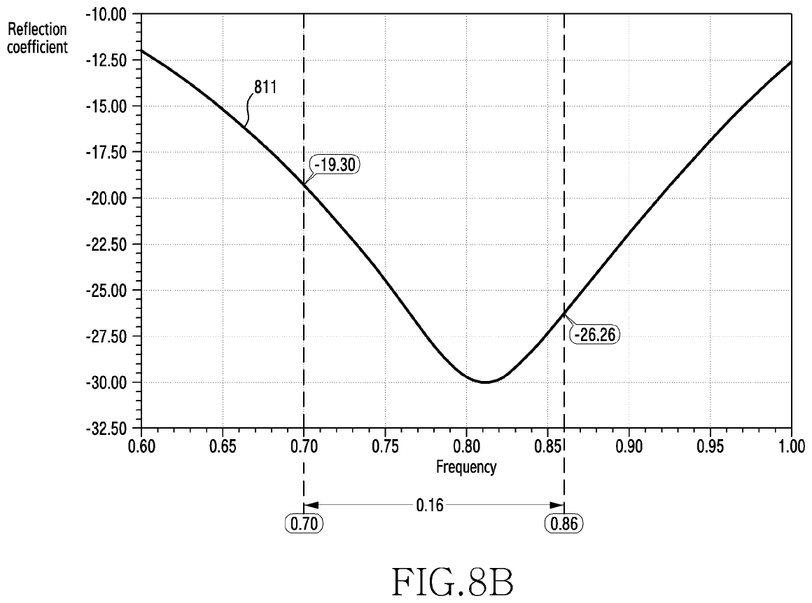

FIG. 8A illustrates a graph for a power split ratio according to a first embodiment of the present disclosure.

Referring to FIG. 8A, the x-axis of the power split ratio graph represents a frequency of a signal transmitted to each output port or input port, and the y-axis thereof represents a power split ratio of a signal transmitted to each output port or input port.

In this case, a curve 801 represents a power split ratio of a signal transmitted to the output port P1 corresponding to each frequency. A curve 803 represents a power split ratio of a signal transmitted to the output port P2 corresponding to each frequency. A curve 805 represents a power split ratio of a signal transmitted to the output port P3 corresponding to each frequency. A curve 807 represents a power split ratio of a signal transmitted to the output port P4 corresponding to each frequency. A curve 809 represents a power split ratio of a signal transmitted to the input port corresponding to each frequency. For example, if the frequency is 0.7 GHz, the power split ratio of the signal transmitted to output port P1 may be 0.38. If the frequency is 0.7 GHz, the power split ratio of the signal transmitted to the output port P2 may be 0.33. If the frequency is 0.7 GHz, the power split ratio of the signal transmitted to the output port P3 may be 0.12. If the frequency is 0.7 GHz, the power split ratio of the signal transmitted to the output port P4 may be 0.11. If the frequency is 0.7 GHz, the power split ratio of the signal reflected by the input port may be 0.01.

FIG. 8B illustrates an S-parameter graph for the reflection coefficient according to a first embodiment of the present disclosure.

Referring to FIG. 8B, the x-axis of the reflection coefficient graph represents a frequency of a signal transmitted to the input port, and the y-axis represents a reflection coefficient of a signal transmitted to the input port. Here, the reflection coefficient indicates the ratio of the input voltage to the output voltage of the input port. That is, the reflection coefficient may be the ratio of the voltage input to the input port to the voltage reflected by the input port.

In this case, a curve 811 represents the reflection coefficient for the signal transmitted to the input port depending on respective frequencies. For example, if the frequency of the signal transmitted to the input port is 0.7 GHz, the reflection coefficient for the signal transmitted to the input port may be −19.30. In addition, it can be seen that the reflection coefficient drops sharply in a specific frequency band (for example, 0.7 GHz to 0.86 GHz), which may mean that the input voltage is not reflected and is discharged as much as possible to the outside in the corresponding frequency band. This indicates that the lower the reflection coefficient, the better the radiating characteristic of the beam-tilt antenna 100. In addition, it is possible to identify a broadband or a narrowband depending on whether the width of the frequency band in which the reflection coefficient drops sharply is wide or narrow.

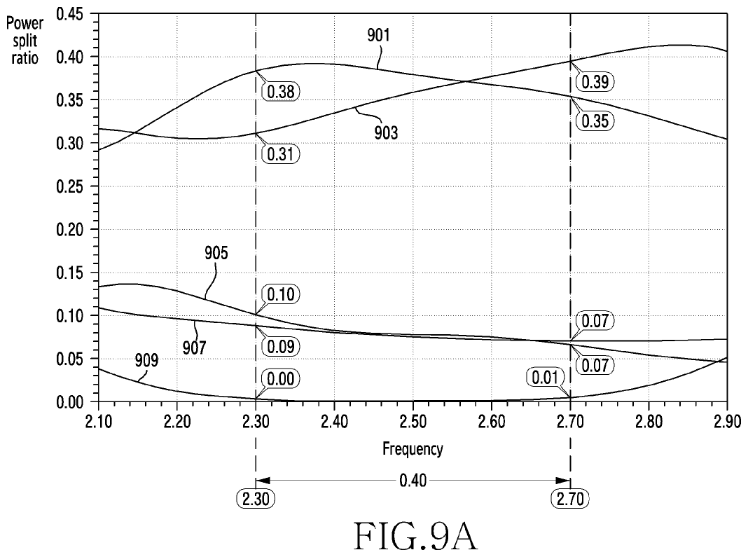

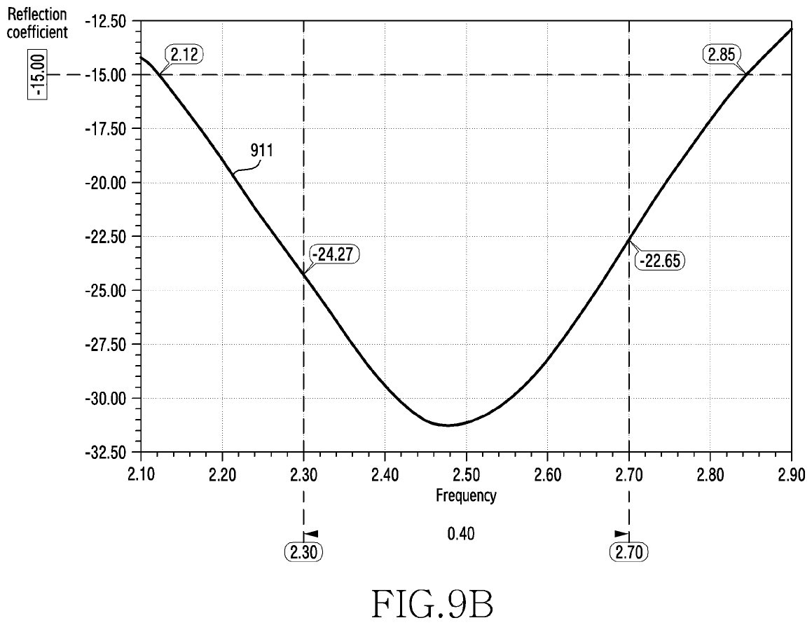

FIG. 9A illustrates a graph for a power split ratio according to a second embodiment of the present disclosure.

Referring to FIG. 9A, the x-axis of the power split ratio graph represents the frequency of a signal transmitted to each output port or input port, and the y-axis thereof represents a power split ratio of a signal transmitted to each output port or input port.

In this case, a curve 901 represents a power split ratio of a signal transmitted to the output port P1 corresponding to each frequency. A curve 903 represents a power split ratio of a signal transmitted to the output port P2 corresponding to each frequency. A curve 905 represents a power split ratio of a signal transmitted to the output port P3 corresponding to each frequency. A curve 907 represents a power split ratio of a signal transmitted to the output port P4 corresponding to each frequency. A curve 909 represents a power split ratio of a signal transmitted to the input port corresponding to each frequency. For example, if the frequency is 0.7 GHz, the power split ratio of the signal transmitted to output port P1 may be 0.38. If the frequency is 0.7 GHz, the power split ratio of the signal transmitted to the output port P2 may be 0.31. If the frequency is 0.7 GHz, the power split ratio of the signal transmitted to the output port P3 may be 0.10. If the frequency is 0.7 GHz, the power split ratio of the signal transmitted to the output port P4 may be 0.09. If the frequency is 0.7 GHz, the power split ratio of the signal reflected by the input port may be 0.001.

FIG. 9B illustrates an S-parameter graph for the reflection coefficient according to a second embodiment of the present disclosure.

Referring to FIG. 9B, the x-axis of the reflection coefficient graph represents a frequency of a signal transmitted to the input port, and the y-axis represents a reflection coefficient of a signal reflected by the input port. Here, the reflection coefficient indicates the ratio of the input voltage to the output voltage of the input port. That is, the reflection coefficient may be the ratio of the voltage input to the input port to the voltage output from the input port.

In this case, a curve 911 represents the reflection coefficient for the signal transmitted to the input port depending on respective frequencies. For example, if the frequency of the signal transmitted to the input port is 2.30 GHz, the reflection coefficient for the signal transmitted to the input port may be −24.27. In addition, it can be seen that the reflection coefficient drops sharply in a specific frequency band (for example, 2.30 GHz to 2.70 GHz), which may mean that the input voltage is not reflected and is discharged as much as possible to the outside in the corresponding frequency band. This indicates that the lower the reflection coefficient, the better the radiation characteristic of the beam-tilt antenna 100. For example, the radiating characteristic of the beam-tilt antenna 100 can be satisfied when the reflection coefficient is equal to or less than −15.00.

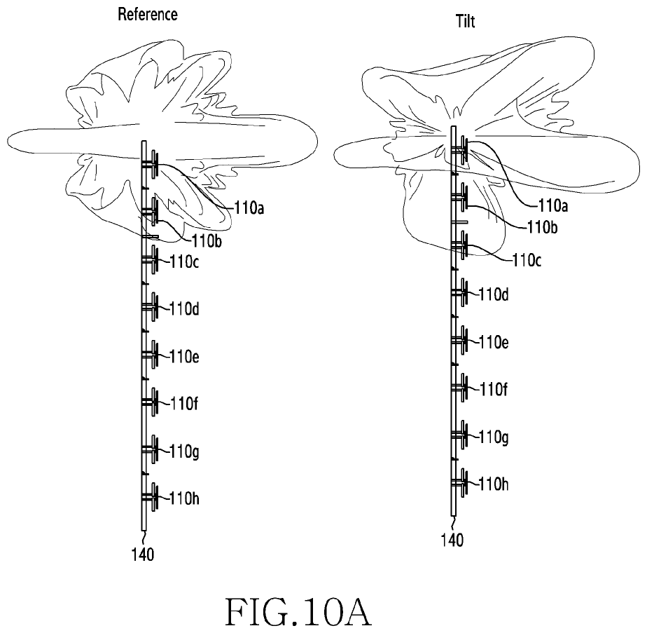

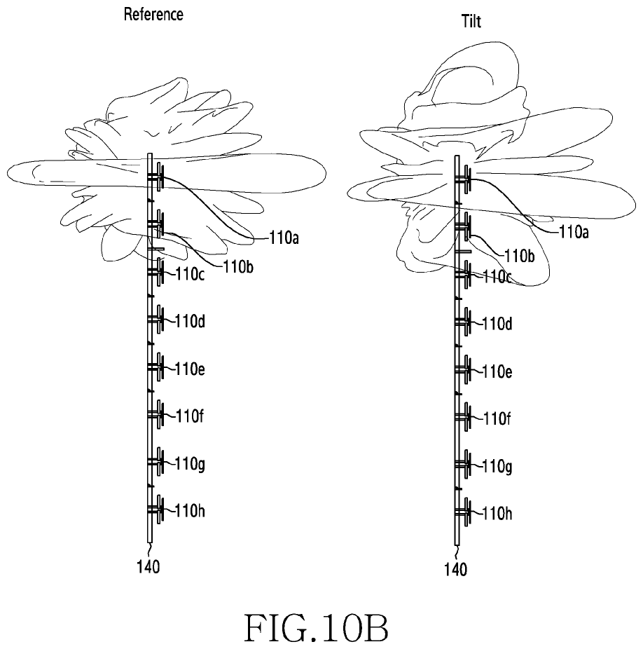

FIG. 10A illustrates an example of a beam pattern change of a beam-tilt antenna depending on a phase change according to a first embodiment of the present disclosure. FIG. 10B illustrates an example of a beam pattern change of a beam-tilt antenna depending on a phase change according to a second embodiment of the present disclosure.

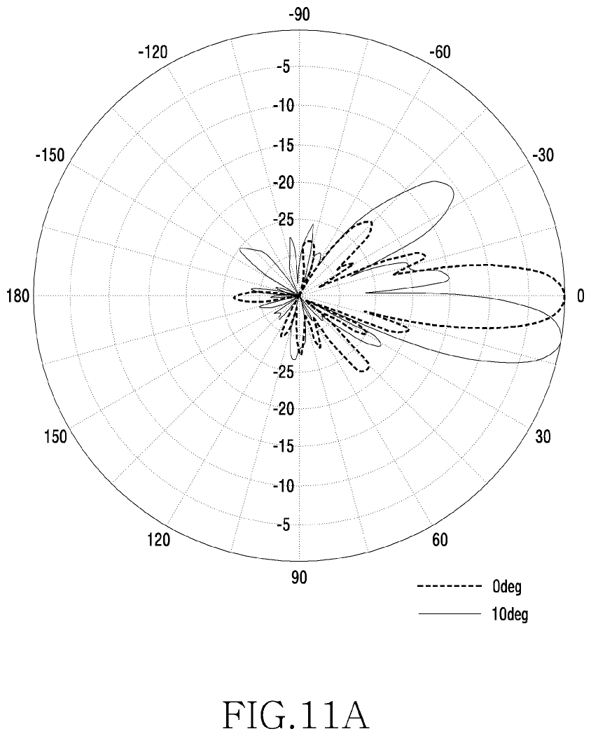

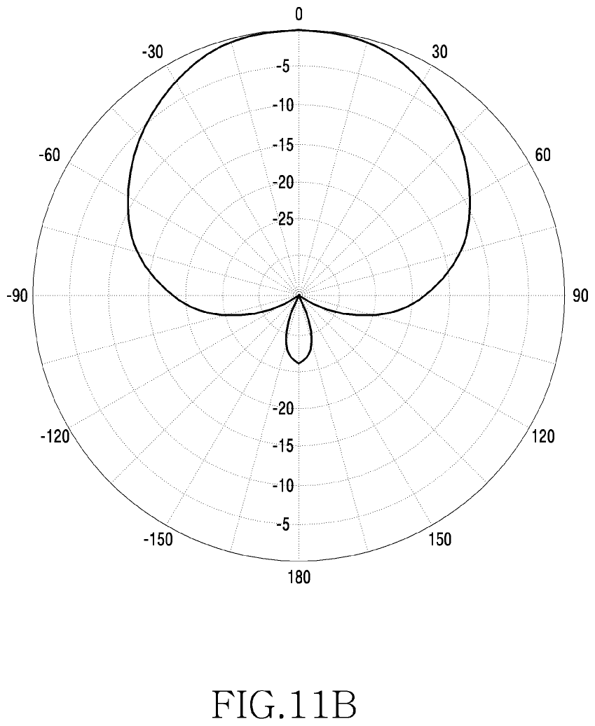

Referring to FIGS. 10A and 10B, it can be seen that the beam radiated from a radiating element 110a included in the beam-tilt antenna 100 is tilted in the vertical direction when the first board 211 rotates. In this case, it can be seen that the beam-tilt angles are different between the case where the first board 211 and the second board 212 have the rail structure shown in FIGS. 3A to 3C according to the first embodiment and the case where the first board 211 and the second board 212 have the rail structure shown in FIGS. 5A to 5C according to the second embodiment when the first board 211 rotates at the same angle. For example, referring to FIGS. 11A and 11B, it can be seen that when the first board 211 and the second board 212 have the rail structure shown in FIGS. 3A to 3C according to the first embodiment, the vertical beam pattern is changed by 10′ in the vertical beam pattern characteristic diagram of the beam-tilt antenna 100. In this case, it is confirmed that the horizontal beam pattern is not changed in the horizontal beam pattern characteristic diagram of the beam-tilt antenna 100. However, in various embodiments, the horizontal beam pattern may also vary depending on various factors such as the orientation of the beam-tilt antenna 100, the arrangement of the radiating elements 110a to 110h, and the like.

Embodiments of the present disclosure provided in the present specifications and drawings are merely certain examples to readily describe the technology associated with embodiments of the present disclosure and to help understanding of the embodiments of the present disclosure, but may not limit the scope of the embodiments of the present disclosure. Therefore, in addition to the embodiments disclosed herein, the scope of the various embodiments of the present disclosure should be construed to include all modifications or modified forms drawn based on the technical idea of the various embodiments of the present disclosure.

In the above-described detailed embodiments of the present disclosure, a component included in the present disclosure is expressed in the singular or the plural according to a presented detailed embodiment. However, the singular form or plural form is selected for convenience of description suitable for the presented situation, and various embodiments of the present disclosure are not limited to a single element or multiple elements thereof. Further, either multiple elements expressed in the description may be configured into a single element or a single element in the description may be configured into multiple elements.

While the present disclosure has been shown and described with reference to certain embodiments thereof, it will be understood by those skilled in the art that various changes in form and details may be made therein without departing from the scope of the present disclosure. Therefore, the scope of the present disclosure should not be defined as being limited to the embodiments, but should be defined by the appended claims and equivalents thereof.

1. A phase shifter device comprising:
a first board configured to comprise a phase changing rail; and
a second board configured to comprise an input rail connected to an input port, a first output rail connected to a first output port, a second output rail connected to a second output port, and a connection rail connecting the first output rail with the second output rail,
wherein the first board is disposed to be spaced a predetermined distance apart from the second board so as to face and overlay the second board,
wherein the phase of a signal passing through a first section of the connection rail varies by a first value depending on rotation of the first board, and
wherein the signal is divided into a first signal transmitted to the first output port and a second signal transmitted to the second output port.

2. The device of claim 1, wherein the connection rail comprises a first division point where an input signal passing through the input rail is divided into other signals different from the signal,
wherein the connection rail comprises a second division point where the signal is divided into the first signal and the second signal, and
wherein the first section comprises a portion that ranges from the first division point to the second division point in the connection rail.

3. The device of claim 2, wherein the first division point comprises a point where the phase changing rail and the connection rail are coupled.

4. The device of claim 2, wherein the second board further comprises a third output rail connected to a third output port and a fourth output rail connected to a fourth output port.

5. The device of claim 4, wherein the phase of the other signal passing through a second section of the connection rail varies by the first value depending on the rotation of the first board.

6. The device of claim 5, wherein the connection rail comprises a third division point where the other signal is divided into a third signal transmitted to the third output port and a fourth signal transmitted to the fourth output port, and
wherein the second section comprises a portion that ranges from the first division point to the third division point in the connection rail.

7. The device of claim 6, wherein the phase of the signal passing through the first section of the connection rail increases by the first value, and wherein the phase of the other signal passing through the second section of the connection rail decreases by the first value.

8. The device of claim 1, wherein the first board further comprises another phase changing rail and the second board further comprises another connection rail, and
wherein the another phase changing rail connects the another connection rail with the first output port.

9. The device of claim 8, wherein the phase of the first signal passing through a portion of the another phase changing rail varies by a second value depending on the rotation of the first board.

10. The device of claim 9, wherein the portion of the another phase changing rail comprises a portion that can be further coupled to the first output rail in the another phase changing rail as the first board rotates.

11. The device of claim 9, wherein the first value is less than the second value.

12. The device of claim 1, wherein the second board further comprises a third output rail connected to a third output port,
wherein the third output rail is connected to the input rail, and
wherein an input signal having passed through the input rail is transmitted to the third output rail without a phase change.

13. The device of claim 1, wherein the connection rail has a comb-line shape.

14. The device of claim 1, wherein a length of the first section of the connection rail varies by a rotation angle of the first board.

15. The device of claim 1, further comprising a motor configured to rotate the first board.

16. An antenna device comprising:
a housing;
a first radiating element and a second radiating element configured to be disposed inside the housing; and
a phase shifter configured to be disposed inside the housing,
wherein the phase shifter comprises a first board configured to comprise a phase changing rail and a second board configured to comprise an input rail connected to an input port, a first output rail connected to a first output port, a second output rail connected to a second output port, and a connection rail connecting the first output rail with the second output rail,
wherein the first board is disposed to be spaced a predetermined distance apart from the second board so as to face and overlay the second board,
wherein the phase of a signal passing through a first section of the connection rail varies by a first value depending on rotation of the first board, and
wherein the signal is divided into a first signal transmitted to the first output port and a second signal transmitted to the second output port.

17. The device of claim 16, wherein the first radiating element radiates the first signal and the second radiating element radiates the second signal.

18. The device of claim 16, wherein the connection rail comprises a first division point where an input signal having passed through the input rail is divided into other signals different from the signal,
wherein the connection rail comprises a second division point where the signal is divided into the first signal and the second signal, and
wherein the first section comprises a portion that ranges from the first division point to the second division point in the connection rail.

19. The device of claim 18, wherein the second board further comprises a third output rail connected to a third output port and a fourth output rail connected to a fourth output port.

20. The device of claim 19, wherein the connection rail comprises a third division point where the other signal is divided into a third signal transmitted to the third output port and a fourth signal transmitted to the fourth output port,
wherein the phase of the other signal passing through a second section of the connection rail varies by the first value depending on the rotation of the first board, and
wherein the second section comprises a portion that ranges from the first division point to the third division point in the connection rail.
